(19) United States
(12) Patent Application Publication
(10) Pub. No.: US 2003/0133263 A1
(43) Pub. Date: Jul. 17, 2003

(54) Uninterruptible power supply (UPS) with built-in USB hub

(75) Inventor: Joseph Shu, Hsin Tien City (TW)

Correspondence Address: Troxell Law Office, Suite 1404, 5205 Leesburg Pike, Falls Church, VA, 22041, US

(73) Assignee: H.L.L. INVESTMENT, LTD.

(21) Appl. No.: 10/047,063

(22) Filed: Jan. 17, 2002

(51) Int. Cl. G06F 1/16

(52) U.S. Cl. 361/685

(57) ABSTRACT

The invention provides a kind of UPS with a built-in USB. The invention consists of a cover, a control circuit of UPS, a USB hub circuit, an electric transformer and a rechargeable battery. The cover has at least one control button and signal light. The control circuit of the UPS has a USB power conversion circuit to transform 12V current of the UPS to 5V current power for working voltage supply by the USB hub circuit. The UPS connects to computer devices through a USB cable and utilizes a power control software on the computer to monitor power supply of the UPS.

### BACKGROUND OF THE INVENTION

1. Field of the Invention

The invention relates to uninterruptible power supply (UPS) equipment with a built-in universal serial bus (USB). More specifically, the invention relates to a device design that integrates a USB hub with an uninterruptible power supply (UPS) to simplify the UPS device, computer hardware and connected cables of its peripheral.

2. Background Art and Problems to be Resolved

Insufficient electric power supply in default of universal energy all over the world increasingly heightens dependence on the needs of uninterruptible power supplies (UPSs) to computer devices or other delicate instruments. General uninterruptible power supplies (UPSs) provide stable alternating (AC) power protection and electric power supply against utility power outage. Moreover, some higher levels of uninterruptible power supplies (UPSs) further provide RS-232 cables connecting to computer devices and monitor AC power status of uninterruptible power supplies (UPSs) through a power monitoring software to increase added-value of uninterruptible power supplies (UPSs). However, such kind of device complicates an uninterruptible power supply (UPS). Besides, extra telephone lines or network lines connected with the uninterruptible power supply (UPS) for the function of lightening protection makes a multitude of cable connections, such as a power cord, a RS-232 cable, telephone lines, network lines, etc., entangled in a clutter.

In addition, a hodgepodge of cable connections of a computer and its peripheral hardware/devices nowadays catalyzes a kind of Universal Serial Bus (hereinafter USB) interface to be developed for simplifying mutual cable connections of a computer and its peripheral hardware. The USB interface is capable of connecting a monitor, a printer, a scanner, a keyboard, or a mouse, etc. in series to a computer and its peripheral devices. Besides, it can further utilize the USB hub to connect the above-mentioned computer devices altogether prior to the connection of a computer. Hence, cable connections of computer devices can be much more simplified. In the meanwhile, it becomes popular among users and receives support from vendors when the USB interface hits the market for having functions of ‘plug-and-play’ and ‘hot-swap’ inside.

Hence, the inventor of the disclosed invention aims at the above-mentioned disadvantages of uninterruptible power supply (UPS) equipment and the advantage of the USB interface integrating the USB interface into a uninterruptible power supply (UPS) equipment. Therefore, the disclosed uninterruptible power supply (UPS) equipment with a built-in USB is developed combining with effectiveness of USB hub to simplify cable connections of a computer and its peripheral devices as well as to simplify cable connections of the uninterruptible power supply (UPS).

### OBJECTS OF THE INVENTION

The main object of the invention is to provide an uninterruptible power supply (UPS) with a built-in USB hub. It utilizes a built-in USB hub on an uninterruptible power supply (UPS) to increase added-value of the uninterruptible power supply (UPS) and to simplify the uninterruptible power supply (UPS) equipment, cable connections of a computer and its peripheral devices.

The second object of providing an uninterruptible power supply (UPS) with built-in USB hub according to the invention is to transform power of an uninterruptible power supply (UPS) to required power of a USB hub without using an extra or an external electric transformer to input power. Thus, information transfer among peripheral equipment can not be interrupted during a power outage.

Another object of providing an uninterruptible power supply (UPS) with a built-in USB hub according to the invention is to utilize the USB interface and cables connecting to computer devices, and through power controlling software to monitor electric power status from an uninterruptible power supply (UPS).

### SUMMARY OF THE INVENTION

In view of the foregoing, the invention provides the following technical solutions to achieve the above-mentioned objects. The invention relates to an uninterruptible power supply (UPS) with a built-in USB hub. The chief distinction of the invention is that the uninterruptible power supply (UPS) includes: a cover, on which there is a power cord, at least one power outlet, and at least one USB interface socket. The enclosure of the cover is an inner space. The inner space includes one control circuit board to supply power and control signals of an uninterruptible power supply (UPS) and transfer signals of the USB. It further includes one electric transformer to transform general AC current into low-voltage of AC current for power supply of the control circuit board; and one rechargeable battery to store electric power against a power outage.

The second distinction of the invention, an uninterruptible power supply (UPS) with a built-in USB hub, is that a USB interface built in the uninterruptible power supply (UPS) is connected to a computer device through a USB cable to monitor power supply status of the uninterruptible power supply (UPS). The uninterruptible power supply (UPS) further comprises: one USB cable is to connect signals between the uninterruptible power supply (UPS) and a computer; one USB interface circuit is to transfer signals of the control circuit to computer devices, or transfer signals of computer devices to the control circuit; one power control software running on a computer is to monitor power supply of the uninterruptible power supply (UPS).

Other objects and effectiveness of the invention will become more fully understood from the detailed description and figures given hereinbelow.

### BRIEF DESCRIPTION OF THE DRAWINGS

FIG. 1 is a solid exterior view of the disclosed uninterruptible power supply (UPS) with a built-in USB hub according to the invention;

FIG. 2 is a solid exploded view of the disclosed uninterruptible power supply (UPS) with a built-in USB hub according to the invention;

FIGS. 3A-E are control circuit diagrams of the disclosed uninterruptible power supply according to the invention;

FIG. 4 is a circuit diagram of the USB hub according to the invention;

FIG. 5 is a schematic view of a cable connection between the invention and a computer hardware; and

FIG. 6 is a circuit diagram of signal transforming from the USB interface to the RS-232 interface.

### DETAILED DESCRIPTION OF THE INVENTION

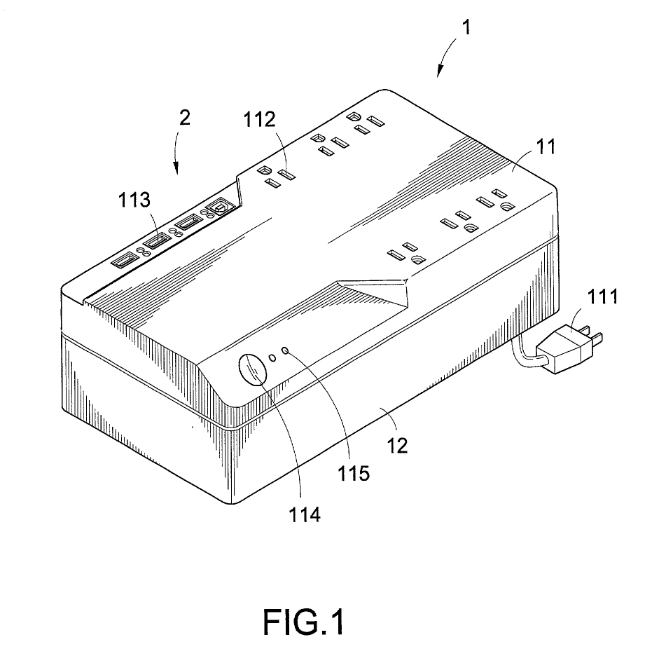

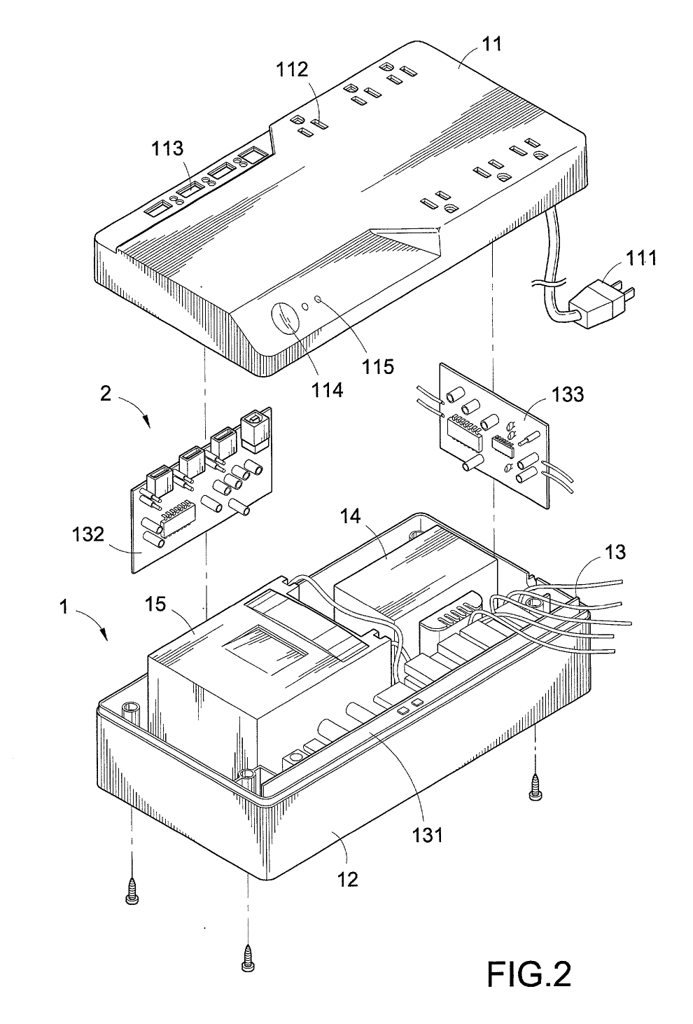

With reference to FIG. 1, a solid exterior view of the disclosed uninterruptible power supply (UPS) with a built-in USB hub according to the invention. FIG. 2 is a solid exploded view of the disclosed uninterruptible power supply (UPS) with a built-in USB hub according to the invention. The disclosed invention is to build in a USB hub 2 in an uninterruptible power supply (UPS) 1. The uninterruptible power supply (UPS) 1 includes a cover, which is comprised of an upper cover 11 and a lower cover 12. There is a power cord 111 on the upper cover to connect AC power socket. The upper cover further consists of at least one power outlet 112 and at least one USB interface socket 113. The cover also includes at least one control button 114 to control switch on or off of the uninterruptible power supply (UPS) 1, and includes a signal lightening 115 to display the status of the uninterruptible power supply (UPS) 1.

The cover consists of the upper cover 11 and the lower cover 12 to form an inner space, in which there are components including: one control circuit board 13, an electric transformer 14 and one rechargeable battery 15. Among those components, the control circuit board 13 generates power supply and controls signals of the uninterruptible power supply (UPS) 1 and generates signals of USB hub 2. The electric transformer 14 transforms general AC power to low-voltage AC power for power supply of control circuit board 13. The rechargeable battery 15 is to store power supply against a power outage.

According to the preferred embodiment of the invention, the control circuit board 13 consists chiefly of: the first circuit board 131, the second circuit board 132, and the third circuit board 133. The first circuit board 131 is the control circuit of the uninterruptible power supply (UPS) 1, the second circuit board 132 is a circuit of the USB hub 2, and the third circuit board 133 is a power conversion circuit (not shown). The power conversion circuit is to transform 12V direct current (DC) power of the control circuit in the uninterruptible power supply (UPS) 1 to 5V DC power to provide working power of the USB hub 2.

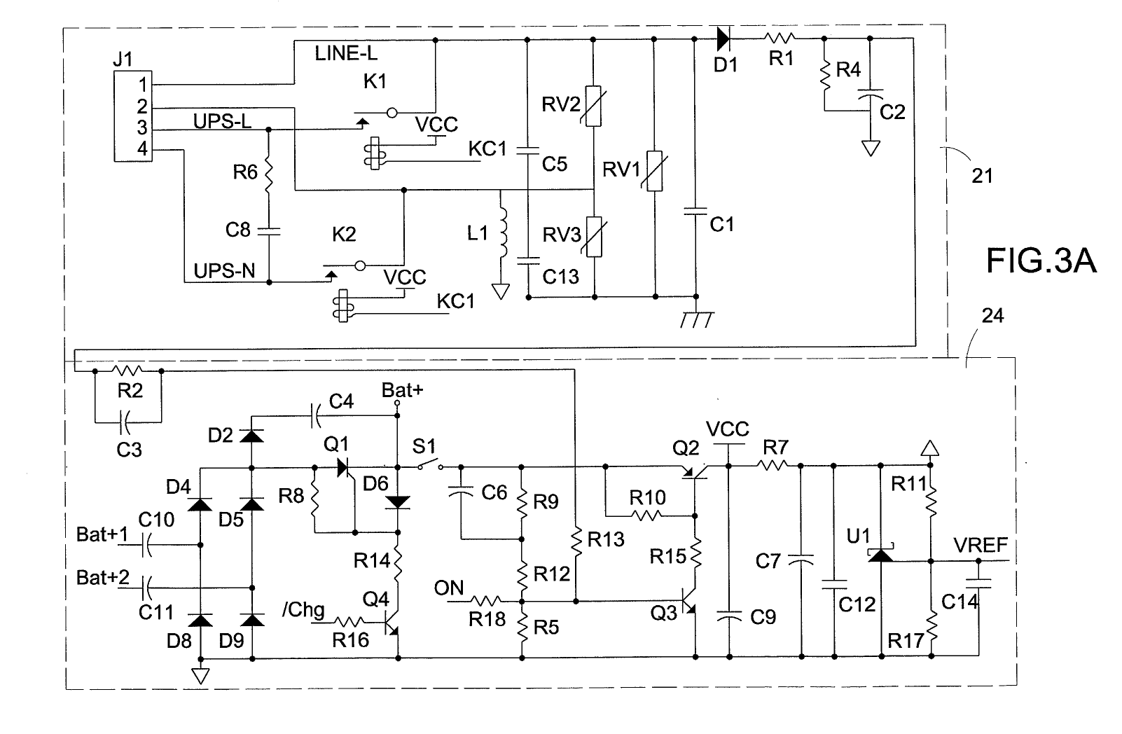

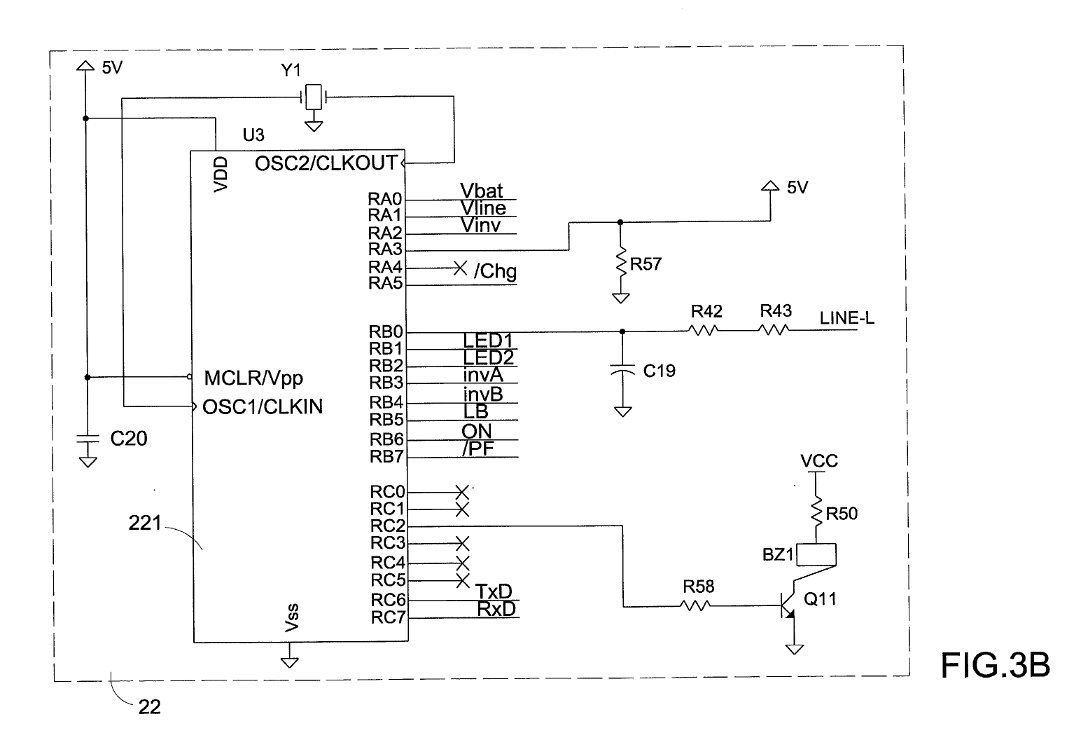

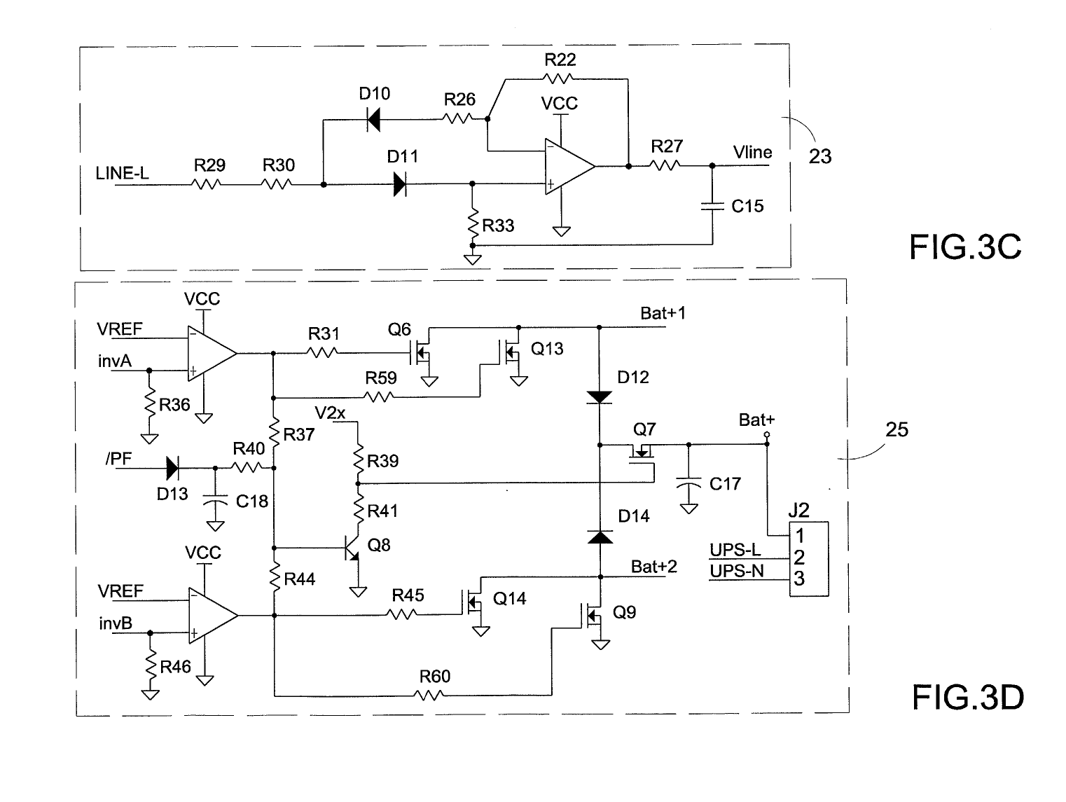

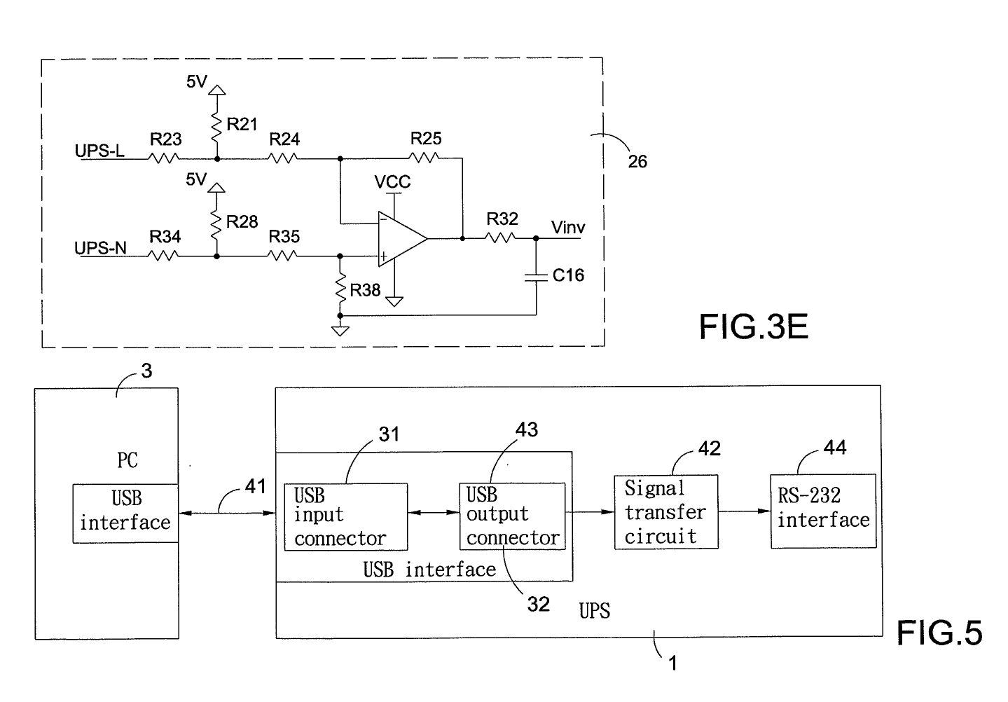

FIGS. 3A-E are control circuit diagrams of the disclosed uninterruptible power supply according to the invention. According to the invention, the control circuit of the uninterruptible power supply (UPS) 1 is on the first circuit board 131. The control circuit includes:

One electric inputting circuit 21 (as shown in FIG. 3-A) makes AC current inputted by the electric transformer 14 to be rectified through diode D4 and regulated by capacitor C2 becomes DC current VCC to supply working power of the whole control circuit board 13. Other components include EMI filter C1, C5, C12 and electric pulse filter RV1, RV2, RV3, . . . etc.

One signal processing circuit 22 (as shown in FIG. 3-B) is the control center of the whole control circuit. Components include one signal processor 221, one crystal oscillator Y1 and one buzzer BZ1 . . . etc.

One AC-voltage detecting circuit 23 (as shown in FIG. 3-C) is to detect status of AC power supply and transfer signals to the signal processor 221 for processing;

One charging circuit 24 (as shown in FIG. 3-A) is controlled by the signal processor 221 to provide charging current for rechargeable battery 15 when the AC power supply is normal;

One DC/AC converter circuit 25 (as shown in FIG. 3-D) is controlled by the signal processor 221 to transform DC current of rechargeable battery 15 to AC current power when there is a power outage;

One power detector circuit 26 (as shown in FIG. 3-E) is to detect output AC power of the DC/AC converter circuit 25 and transfer detected signal to the signal processor 221 for processing.

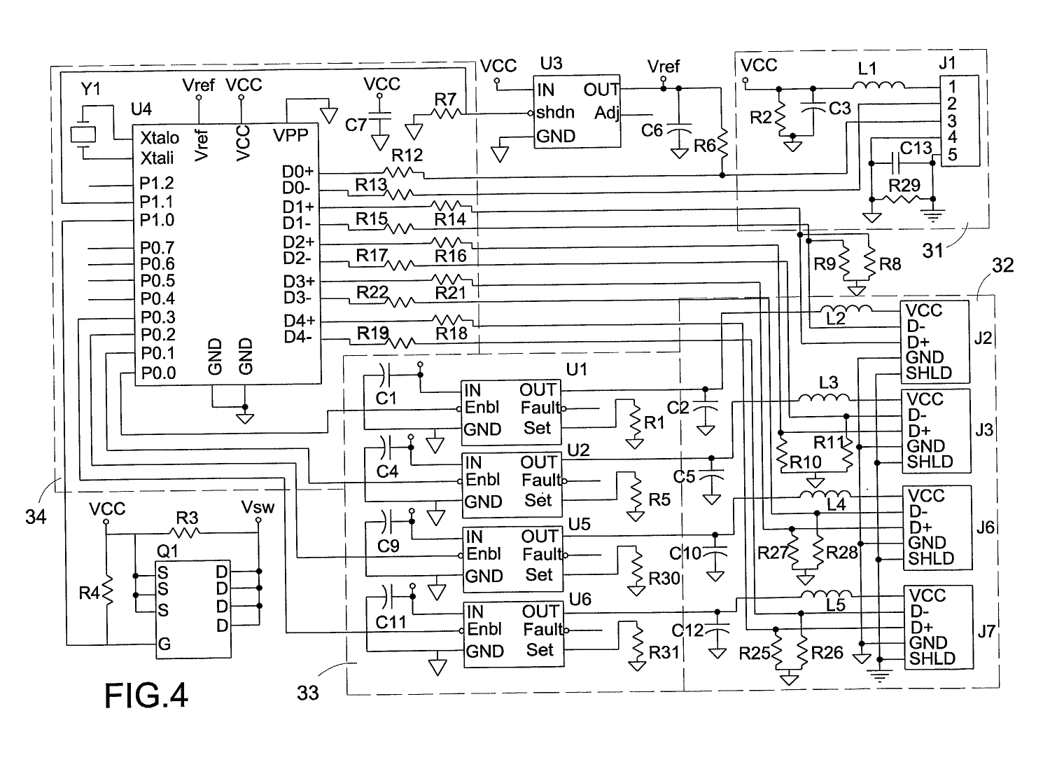

With reference to FIG. 4 a circuit diagram of the USB hub according to the invention. The feature of USB interface enables all peripheral equipment to be connected in serial, nevertheless, a maximum of length for power transformation is about 3.5 meters, so that signals and working power would be tapered off to mislead signal transferring, due to overlong cable lines. Hence, it needs a hub to heighten signals and working power supply when there are more than two peripheral equipment are being used at the same time or the length of cable lines are over 3.5 meters. The second circuit board 132 according to the invention relates to a circuit of the USB hub 2. The circuit is a one to four USB hub, i.e., a circuit diagram with one input port to four output port. The circuit includes:

One USB input connector 31 is to connect computer hardware or Up-link to another USB hub output connectors;

At least one USB output connector 32 to connect peripheral equipment or Down-link to another USB hub input connector;

At least one power amplifier 33 corresponding to the USB output connectors 32 is to provide stable working voltage power for the USB output connectors 32;

One signal processor 34, control center of the whole USB hub circuit 2, is to amplify and transfer signals from the USB input connector 31 to one of the USB output connectors 32, and likewise, from one of the USB output connectors 32 to the USB input connector 31.

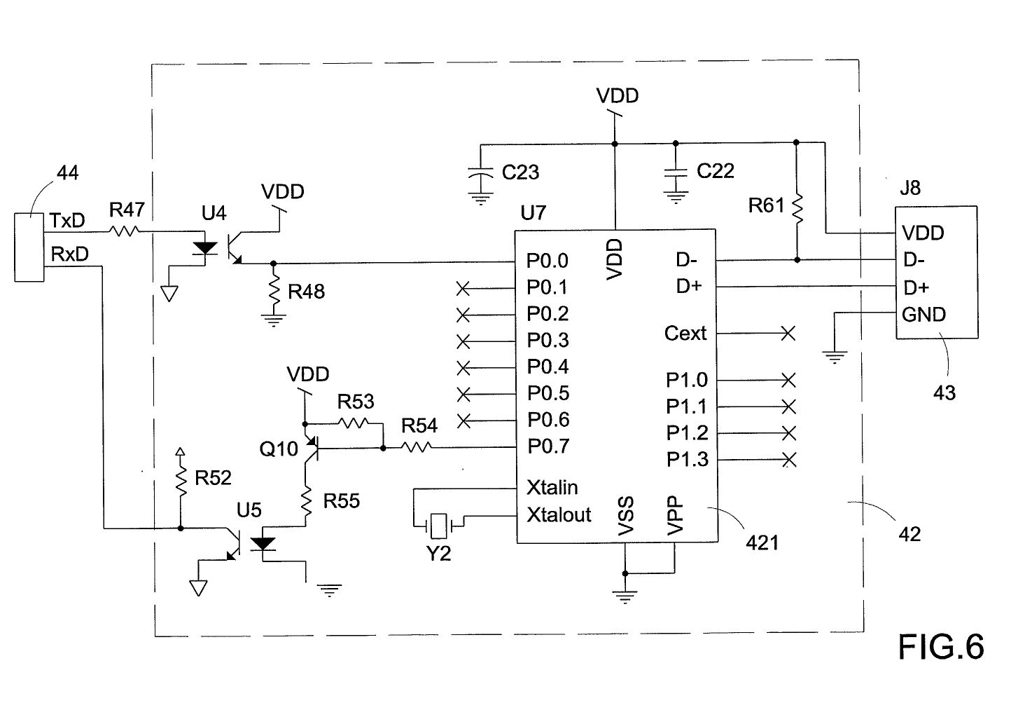

FIG. 5 is a schematic view of a cable connection between a USB cable and computer hardware. FIG. 6 is a circuit diagram of signal transforming from the USB interface to the RS-232 interface. Conventional UPS device utilizes a RS-232 interface 44 connecting to computer hardware 3 and uses a power control software running on computer equipment 3 to monitor power supply of the UPS 1.

The invention is to utilize the USB input connector 31 in the USB hub 2 to connect computer equipment 3 through a USB cable 41. Moreover, the invention utilizes one of the output connectors 32 in the USB hub 2 to connect a signal transfer circuit 42 is to transfer signals of the USB interface 43 to signals of the RS-232 interface 44 as signal connecting bridge between the UPS 1 and computer equipment 3.

The invention, the object of transferring signals from the USB interface 43 to the RS-232 interface 44 aims at remaining unchanged circuit designs of original UPS 1 to achieve signal transformation through the USB interface 43 to the UPS 1. Moreover, the invention can achieve the object of transferring signals from the UPS 1 to computer equipment 3 or from computer equipment 3 to the UPS 1 by directly connecting the USB interface 43 to the control circuit of the UPS 1.

The signal transfer circuit 42 of the invention (as shown in FIG. 6) is controlled by a signal converter 421 for signal transforming control, and is connected to TxD and RxD signals of the RS-232 interface 44 through two light-couplers U4 and U5 to transform signals. The theory of the circuit is that the USB interface 43 firstly transfers signal to D+ of signal converter 421, then pin PO.7 of the signal converter 421 transfers the signal to the light-coupler U5, finally, RxD of the RS-232 interface 44 receives the signal. Contrarily, when pin TxD of the RS-232 interface 44 transfers signal through light-coupler U4 to pin PO.0 of the signal converter 421, D− of the signal converter 421 then transfers the signal to the USB interface. Thus, it achieves the object of transformation from the USB interface to the RS-232 interface.

Features of the Invention

Therefore, UPS with a built-in USB hub of the invention is capable of integrating a USB hub into the UPS through above disclosed infrastructure and circuits and is also capable of transferring signals to computer equipment through the USB hub to skip the need of connecting a RS-232 cable. It further achieves the object of simplifying cable connections of a computer and its peripheral devices as well as cable connections of the UPS.

What is claimed is:

1. A UPS with a built-in USB hub mainly builds a USB hub in the UPS device. The UPS includes:
a cover with one power cord, at least one power outlet, and at least one USB interface sockets on the upper cover. The enclosure of the cover forms an inner space;
at least one control circuit board, which is installed in the inner space of the cover to generate power supply and control signals of the UPS, and transfer signals of a USB hub;
an electric transformer, which is installed in the inner space of the cover to transform AC current power to low-voltage AC current power for required power supply of the control circuit board; and
a rechargeable battery, which is installed in the inner space of the cover to store electric power supply against a power outage.

2. The invention of claim 1, wherein the cover includes at least one control button for switching on and off controls of the UPS.

3. The invention of claim 1, wherein the cover has at least one signal light to display status of the UPS.

4. The invention of claim 1, wherein the control circuit board consists of a control circuit of UPS. The control circuit includes:
an electric inputting circuit, which rectifies and regulates AC power input by the electric transformer to DC current power to supply working voltage of the whole control circuit;
a signal processor, which is the control center of the whole control circuit;
a AC-voltage detecting circuit, which detects general AC power supply and transfers it to the signal processor;
a charging circuit, which is controlled by the signal processor to supply charging current of the rechargeable battery during normal AC power supply;
a DC/AC converter circuit, which is controlled by the signal processor to transform DC current of the rechargeable battery to general AC power supply during power failures; and
a power detector circuit, which detects power voltage of DC/AC conversion and transfers it to the signal processor.

5. The invention of claim 1, wherein the control circuit board further includes a USB hub circuit. The USB hub circuit comprises:
a USB input connector, which connects to computer equipment or Up-link to another USB output connectors;
at least one USB output connector, which connects to peripheral equipment or Down-link to another USB input connector;
at least one power amplifier, which corresponds to the USB output connectors to provide USB output connectors with stable working voltage;
a signal processor, which is the control center of the whole USB hub circuit to transfer signals from USB input connector to one of the USB output connector or from one of the USB output connector to USB input connector.

6. The invention of claim 1, wherein the control circuit board further consists a USB power conversion circuit to transfer 12V DC current using by control circuit of the UPS to 5V DC current for working voltage supply of USB hub circuit.

7. A kind of UPS with a built-in USB hub mainly installs USB interface in the UPS to connect computer equipment through a USB cable and to monitor general AC power supply of the UPS. The UPS comprises:
a cover with one power cord, at least one power outlet, and at least one USB interface sockets on the upper cover. The enclosure of the cover forms an inner space;
a rechargeable battery, which is installed in the inner space of the cover to store electric power supply against a power outage.
a control circuit, which detects general AC power to control charging of a rechargeable battery or transfer DC current of rechargeable battery to general AC power output;
a control circuit board, which is installed in the inner space of the cover to generate power supply and control signals of the UPS, and transfer signals of a USB hub;
an electric transformer, which is installed in the inner space of the cover to transform AC current power to low-voltage AC current power for required power supply of the control circuit board; and
a USB cable, which is signal connection between the UPS and a computer;
a USB interface circuit, which transfers signals from the control circuit to a computer, or from a computer to the control circuit;
a power control software, which implements on a computer to monitor power supply of the UPS.

8. The invention of claim 7, wherein it further consists of a signal transfer circuit to transfer signals from the USB interface circuit to RS-232 interface circuit for signal transformation between the UPS and a computer.

9. The invention of claim 7, wherein the cover has at least one control button to control switching on and off the UPS.

10. The invention of claim 7, wherein the control circuit further consists of a USB power conversion circuit to transfer 12V DC current to 5V DC current for working voltage supply of the USB interface circuit.
